(19) United States
(12) Patent Application Publication
(10) Pub. No.: US 2018/0011561 A1
(43) Pub. Date: Jan. 11, 2018

(54) INFORMATION PROCESSING APPARATUS, INPUT APPARATUS, METHOD OF CONTROLLING INFORMATION PROCESSING APPARATUS, METHOD OF CONTROLLING INPUT APPARATUS, AND PROGRAM

(71) Applicant: Sony Corporation, Tokyo (JP)

(72) Inventors: Hiroto Kawaguchi, Kanagawa (JP); Hiroshi Mizuno, Kanagawa (JP); Akira Ebisui, Kanagawa (JP); Taizo Nishimura, Kanagawa (JP); Yoshiteru Taka, Kanagawa (JP)

(73) Assignee: Sony Corporation, Tokyo (JP)

(21) Appl. No.: 15/546,697

(22) PCT Filed: Dec. 2, 2015
(86) PCT No.: PCT/JP2015/005988

§ 371 Date: Jul. 27, 2017

(30) Foreign Application Priority Data
Feb. 6, 2015 (JP) 2015-022343

(51) Int. Cl. G06F 3/0354; G06F 3/044; G06F 3/0484

(52) U.S. Cl. CPC G06F 3/03547; G06F 3/044; G06F 3/04847

(57) ABSTRACT

Provided is an information processing apparatus, an input apparatus, a method of controlling an information processing apparatus, a method of controlling an input apparatus, and a program capable of improving operability. An information processing apparatus according to an embodiment of the present technology includes a main body, a detection unit, and a control unit. The main body includes a display unit and a casing unit that supports the display unit. The detection unit has a detection area provided on a surface of the casing unit, and is configured to be capable of electrostatically detecting a pressing force to the detection area. The control unit is configured to control an image displayed on the display unit on a basis of a pressing input operation in the detection area and a motion thereof.

### TECHNICAL FIELD

The present technology relates to an information processing apparatus capable of electrostatically detecting an input operation, an input apparatus, a method of controlling an information processing apparatus, a method of controlling an input apparatus, and a program.

### BACKGROUND ART

As a typical input apparatus of a personal computer, a combination of a keyboard for performing character inputs and a pointing device such as a mouse and a touch pad for operating a cursor on a screen is a mainstream. In contrast, in a slate information processing apparatus such as a smart phone and a tablet terminal, the greatest characteristic of an input is performing an operation by touching a screen as an output apparatus configured by a touch panel with a finger directly (see, for example, Patent Literature 1).

### CITATION LIST

### Patent Literature

Patent Literature 1: Japanese Patent Application Laid-open No. 2009-151718

### DISCLOSURE OF INVENTION

### Technical Problem

In a slate information processing apparatus having a display apparatus in which input/output functions are incorporated, a part of a display screen is hidden with a hand or a finger at a time of an operation, which hinders visual confirmation of output information at a time of the operation. On the other hand, when an input operation area on a screen is reduced to secure visual confirmation of output information, this inevitably results in deterioration of operability.

Further, when the display screen is increased, a motion to perform an operation becomes larger. This problem holds true for an input apparatus such as a pointing device in which a motion amount of a cursor on a screen is determined on a basis of a motion amount of a hand and a finger.

In view of the circumstances as described above, it is an object of the present technology to provide an information processing apparatus, an input apparatus, a method of controlling an information processing apparatus, a method of controlling an input apparatus, and a program which can improve operability.

### Solution to Problem

An information processing apparatus according to an embodiment of the present technology includes a main body, a detection unit, and a control unit.
The main body has a display unit and a casing unit that supports the display unit.
The detection unit is configured to have a detection area disposed on a surface of the casing unit and be capable of electrostatically detecting a pressing force to the detection area.
The control unit is configured to control an image displayed on the display unit on a basis of a pressing input operation in the detection area and a motion thereof.

In the information processing apparatus, on a basis of the pressing input operation in the detection area provided on the surface of the casing unit and a motion thereof, the image displayed on the display unit is controlled. Thus, it is possible to control displaying of the image without directly operating the display unit with a finger. As a result, visual confirmation of output information at a time of an operation is improved, and a sufficient display area in order to obtain the output information is ensured.

Further, in the information processing apparatus, because the detection unit is capable of electrostatically detecting the pressing force in the detection area, it is possible to determine whether an input operation is performed or not on a basis of a degree of the pressing force. As a result, it is possible to avoid an input operation unintended by a user.

The main body is typically configured to have such a size as to be capable of being operated while being held by the user. In this case, a surface of the casing unit on which the detection area is provided may be a frame-shaped portion disposed around the display unit in front of the main body or may be a predetermined area on a back surface of the main body opposite to the display unit.

The control unit may be configured to be capable of setting a part of the detection area as an operation area in which the pressing input operation is valid by a selection operation of a user.
with this configuration, it is possible to set the operation area on a desired position in the detection area, so it is possible to provide operability that does not depend on a position of a holding hand of the user who holds the main body and a posture of the main body.

The configuration of the detection unit is not particularly limited. For example, the detection unit includes a sensor sheet, an input operation surface, and a support layer.
The sensor sheet has a plurality of capacitance devices arranged in the detection area in a matrix pattern. The input operation surface has a conductive layer, and is disposed to face the plurality of capacitance devices. The support layer elastically supports the input operation surface with respect to the sensor sheet.
With the configuration described above, on the basis of a capacitance of the capacitance device which is changed depending on a distance between a conductive layer and the sensor sheet, the pressing force to the input operation surface can be detected.

In the detection unit, the plurality of capacitance devices may have a plurality of device columns, arrangement intervals of the plurality of device columns along at least one direction being different from each other. In this configuration, depending on the device column, the number of devices that detect a shift of the finger along the one direction differs. Thus, for example in a pointing operation for an image displayed on the display unit, it is possible to make a shift amount of a cursor on the display unit different from device column to device column. In addition, for example, it is possible to improve pointing operability in an area in which a finger movable range is restricted.

In a case where the main body is configured to be capable of being operated in a state of being held by the user, the detection area has the device columns arranged at shorter intervals as the device columns are closer to a holding portion of the main body. The movable range of a hand and a finger that hold the main body becomes smaller in an area closer to the holding portion generally. Thus, by setting the arrangement intervals of the capacitance devices to be shorter in the area closer to the holding portion, it is possible to achieve an appropriate pointing operation by a shorter operation distance.

The detection unit may further include a structure that is formed on the input operation surface and has a three-dimensional shape. As a result, it is possible to specify a position of the detection unit on the casing in a visual or tactile manner. Further, with the shape, size, or the like of the structure, it is possible to adjust a detection sensitivity with respect to the pressing input operation in the detection area.

An information processing apparatus according to another embodiment of the present technology includes a display unit, an operation member, and a control unit.
The operation member has a key input unit having a plurality of input keys and a detection area configured to be capable of electrostatically detecting a pressing force.
The control unit is configured to control an image displayed on the display unit on a basis of a pressing input operation in the detection area and a motion thereof.

The information processing apparatus includes the control unit configured to be capable of controlling an image displayed on the display unit on the basis of the pressing input operation in the detection area provided to the operation member and the motion thereof. Here, the control unit is configured to electrostatically detect the pressing force on the detection area, so it is possible to perform comprehensive judgement on not only a binary input of on and off but also a degree or the like of a pressure at a time of on, thereby detecting various input operations by the user. As a result, it is possible to provide operability fitted to an intention of a user.

For example, the control unit may be configured to set a part of the detection area as an operation area in which a pressing input operation is valid by a selection operation of a user. In this case, the operation area may be set in a detection area of a predetermined operation (gesture operation or the like) input to the detection area, in a predetermined area including an initial input position in the detection area, or the like. By limiting the operation area, an erroneous operation can be prevented, and an operation area can be customized in accordance with a preference of a user.

An input apparatus according to an embodiment of the present technology includes a key input unit, a detection unit, and a control unit.
The key input unit has a plurality of input keys.
The detection unit has a detection area configured to be capable of electrostatically detecting a pressing force.
The control unit is configured to generate a control signal that controls an image displayed on a display unit on a basis of a pressing input operation in the detection area and a motion thereof.

According to an embodiment of the present technology, there is provided a method of controlling an information processing apparatus having a display unit and a casing unit that supports the display unit, the method of controlling an information processing apparatus includes electrostatically detecting a motion of a pressing input operation in a detection area provided on a surface of the casing unit.
An operation range of the pressing input operation in the detection area is set as an operation area in which an input operation is valid.
An image displayed on the display unit is controlled on a basis of the pressing input operation in the operation area and a motion thereof.

According to an embodiment of the present technology, there is provided a method of controlling an input apparatus having a key input unit having a plurality of input keys and a detection unit having a detection area configured to be capable of electrostatically detecting a pressing force, the method of controlling an input apparatus includes electrostatically detecting a motion of a pressing input operation in the detection area.
An operation range of the pressing input operation in the detection area is set as an operation area in which an input operation is valid.
An image displayed on a display unit is controlled on a basis of the pressing input operation in the operation area and a motion thereof.

According to an embodiment of the present technology, there is provided a program for causing an information processing apparatus having a display unit and a casing unit that supports the display unit to execute:
a step of electrostatically detecting a motion of a pressing input operation in a detection area provided on a surface of the casing unit;
a step of setting an operation range of the pressing input operation in the detection area as an operation area in which an input operation is valid; and
a step of controlling an image displayed on the display unit on a basis of the pressing input operation in the operation area and a motion thereof.

According to another embodiment of the present technology, there is provided a program for causing an input apparatus having a key input unit having a plurality of input keys and a detection unit having a detection area configured to be capable of electrostatically detecting a pressing force to execute:
a step of electrostatically detecting a motion of a pressing input operation in the detection area;
a step of setting an operation range of the pressing input operation in the detection area as an operation area in which an input operation is valid; and
a step of generating a control signal for controlling an image displayed on a display unit on a basis of the pressing input operation in the operation area and a motion thereof.

### ADVANTAGEOUS EFFECTS OF INVENTION

As described above, according to the present technology, it is possible to improve the operability.
It should be noted that the effects described here are not necessarily limited, and any effect described in the present disclosure may be obtained.

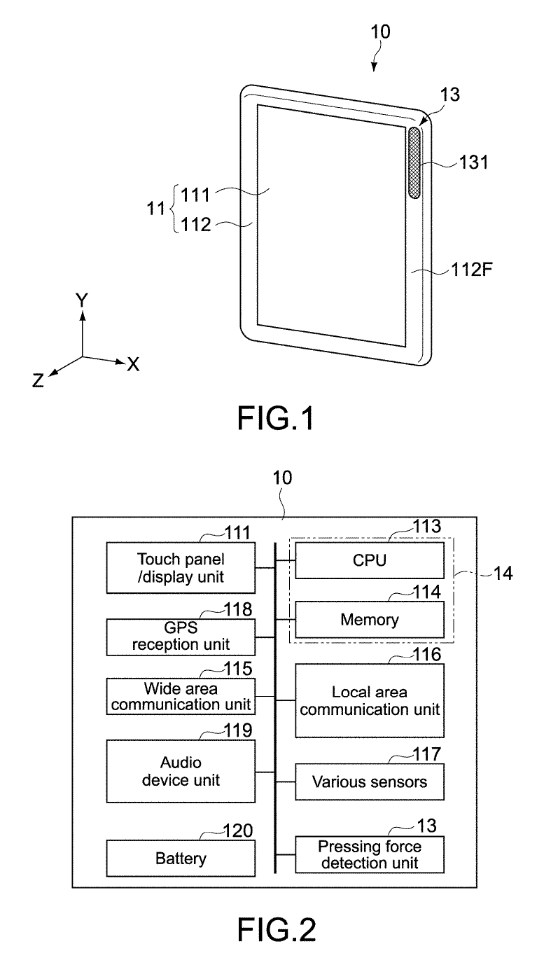

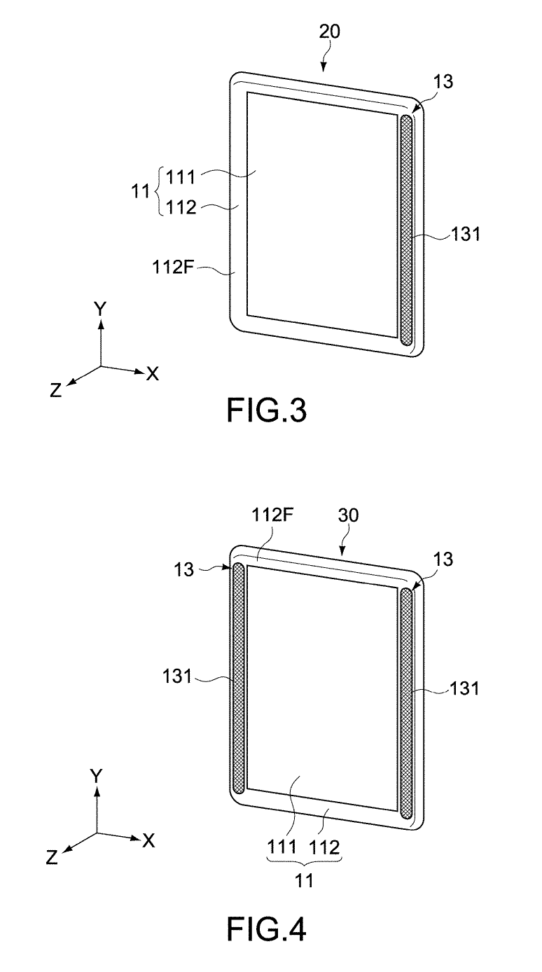

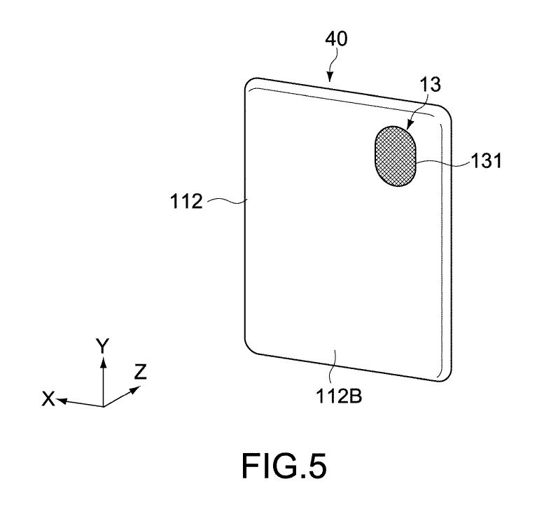

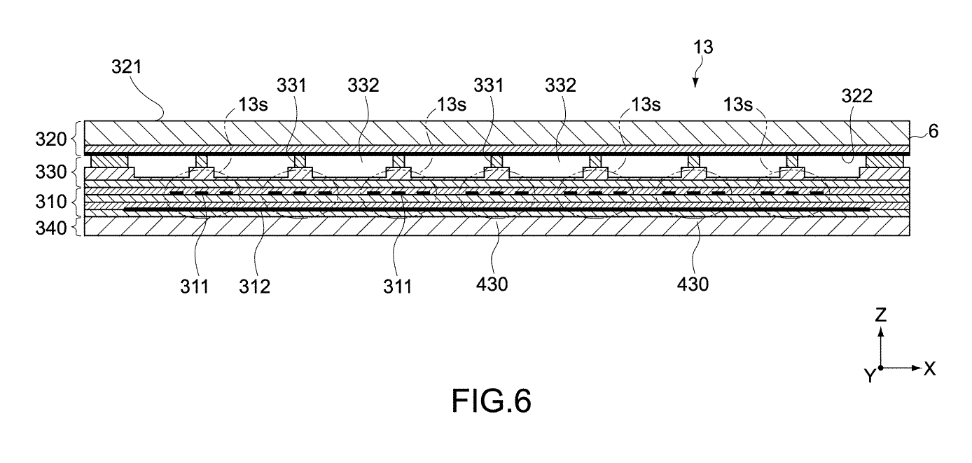

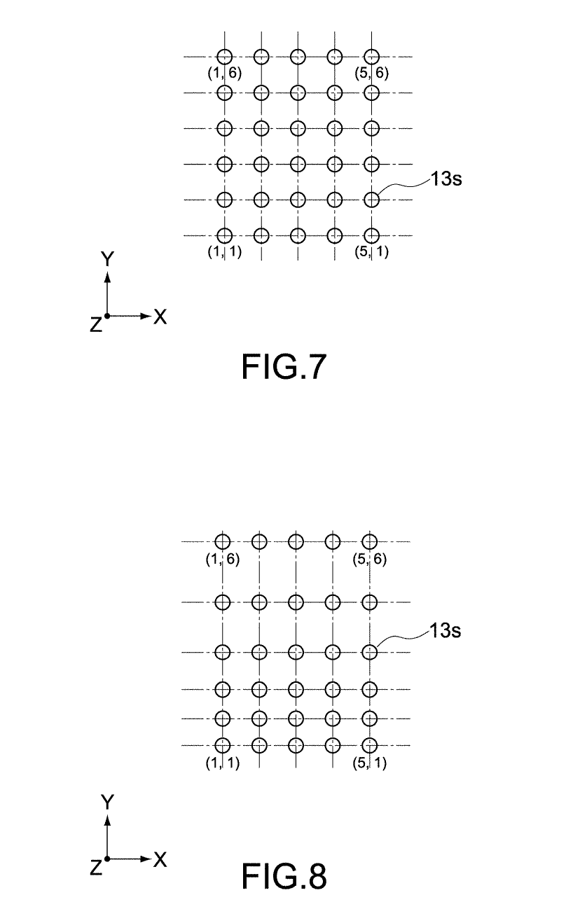

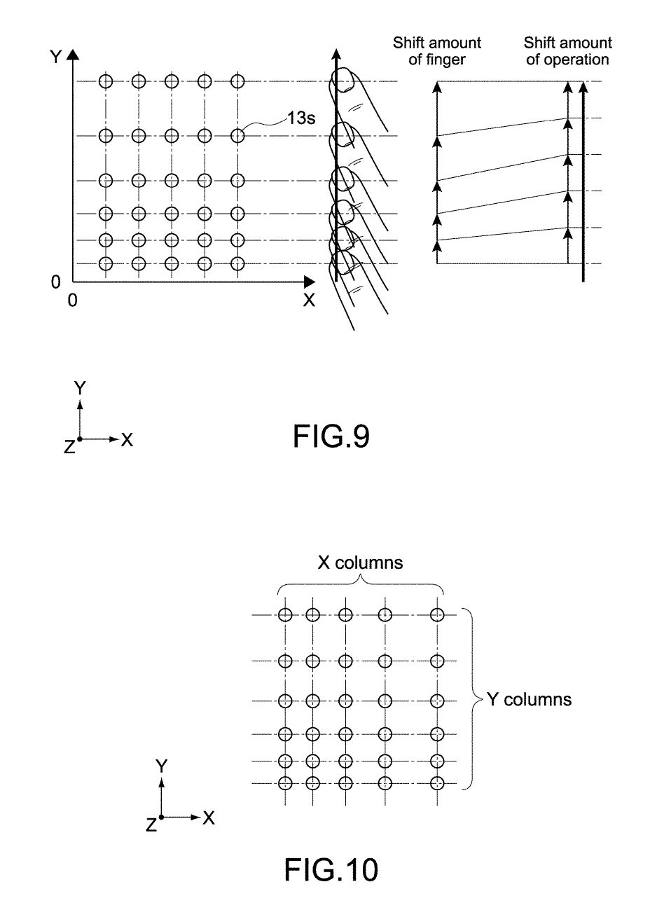

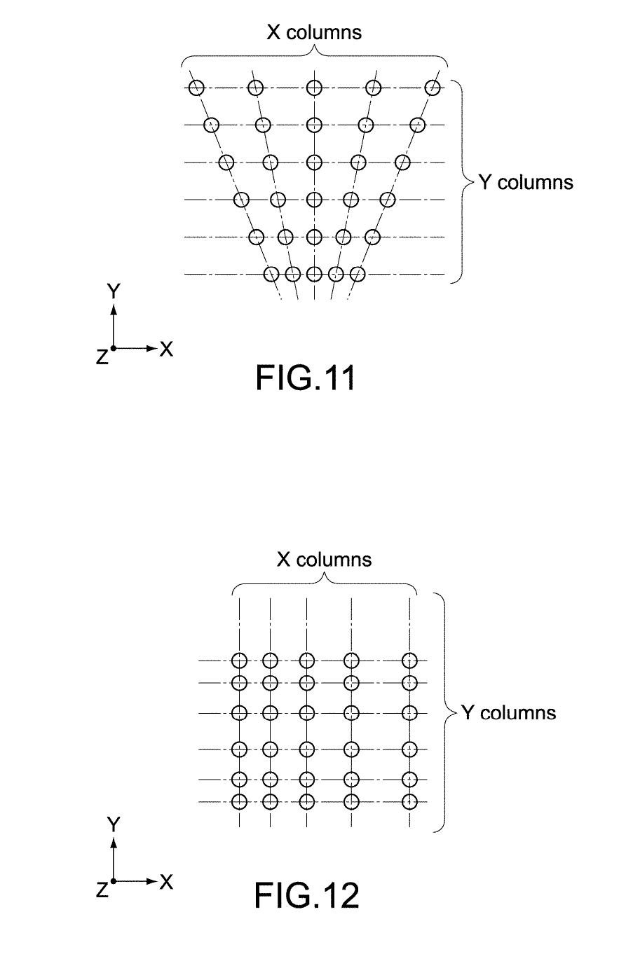

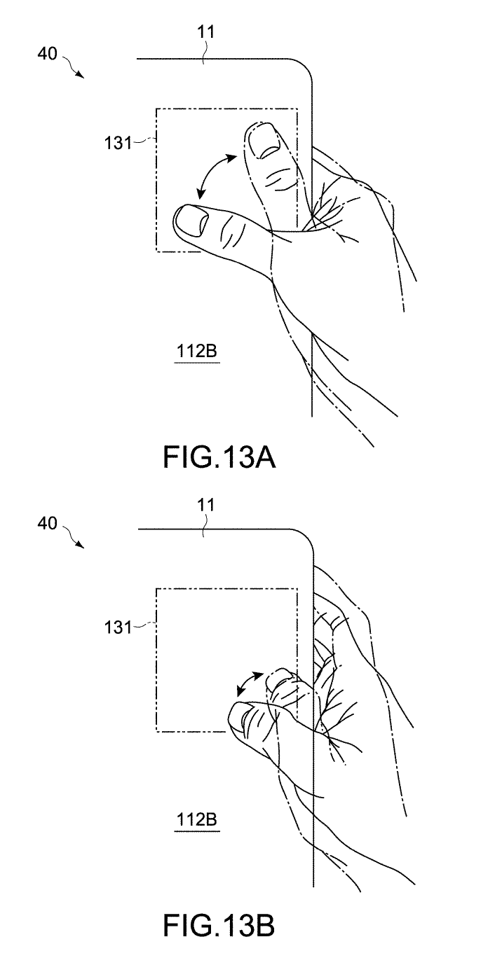

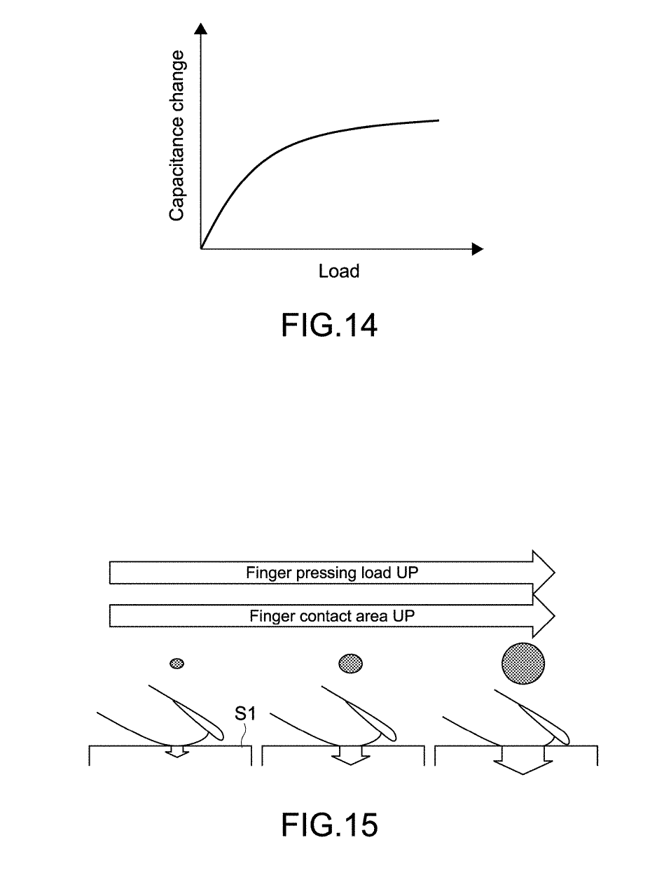

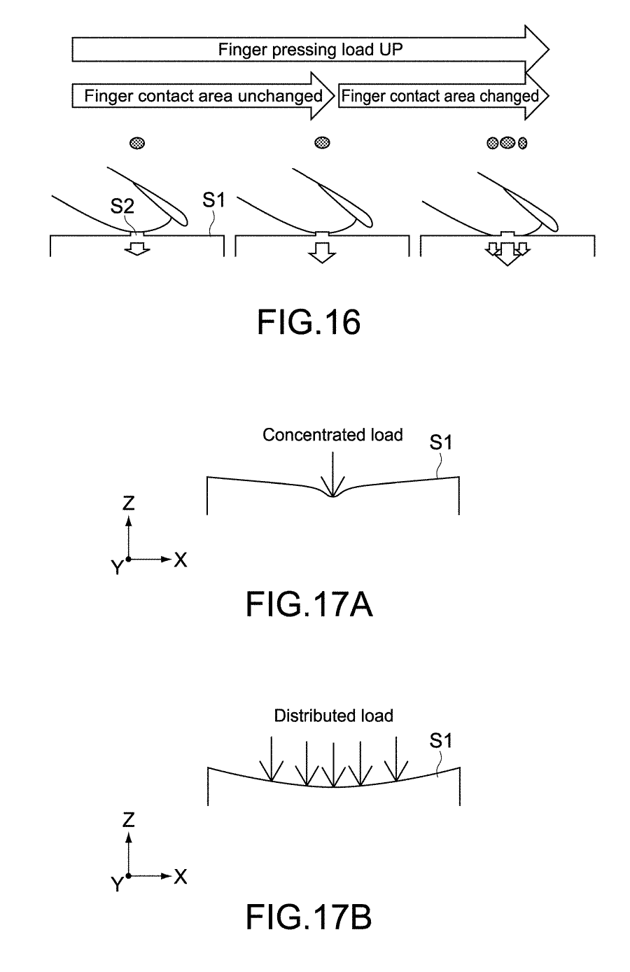

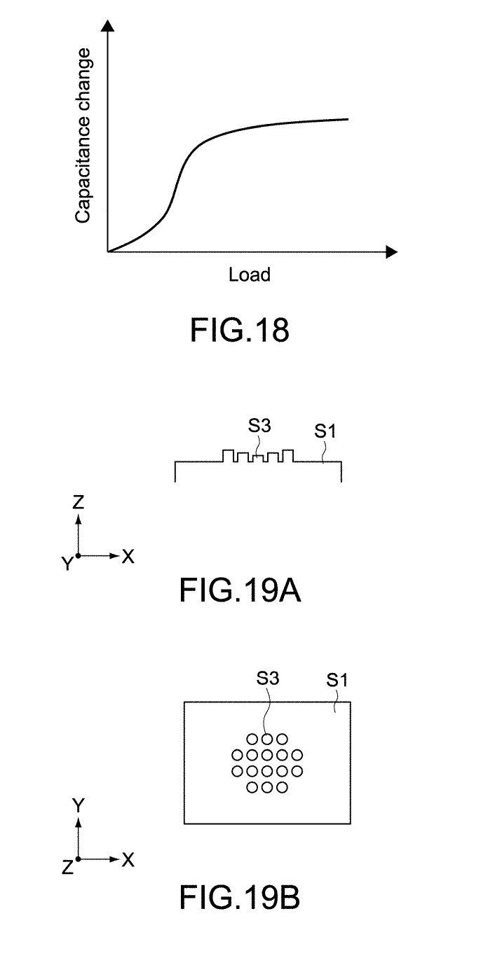

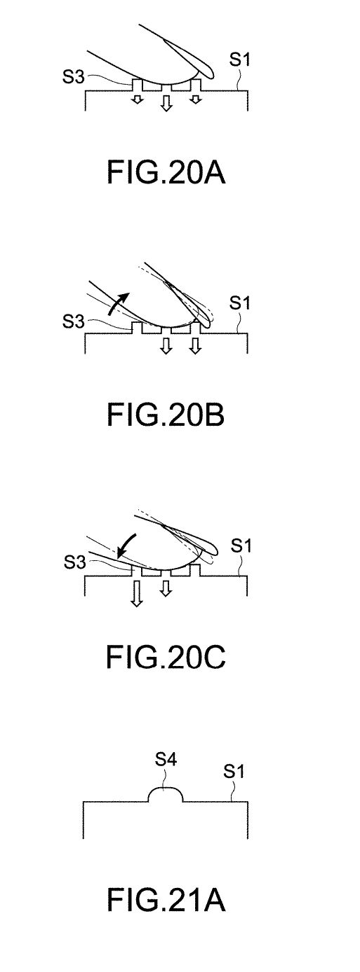

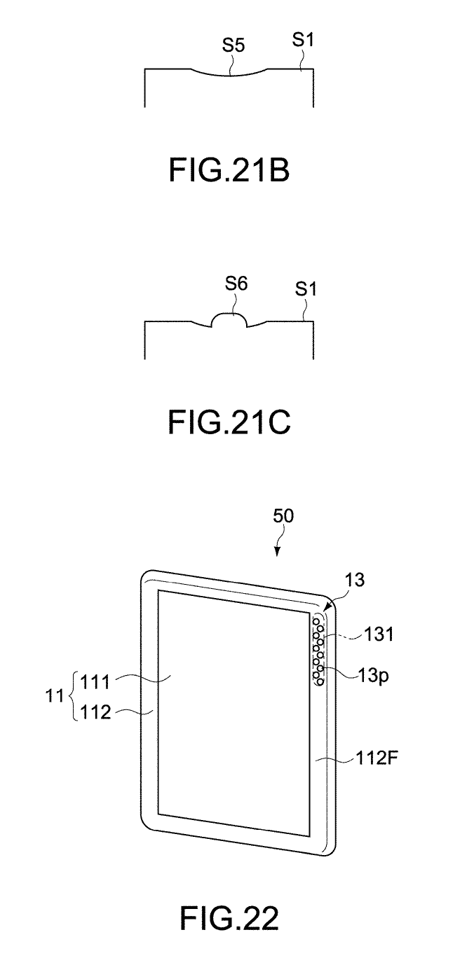

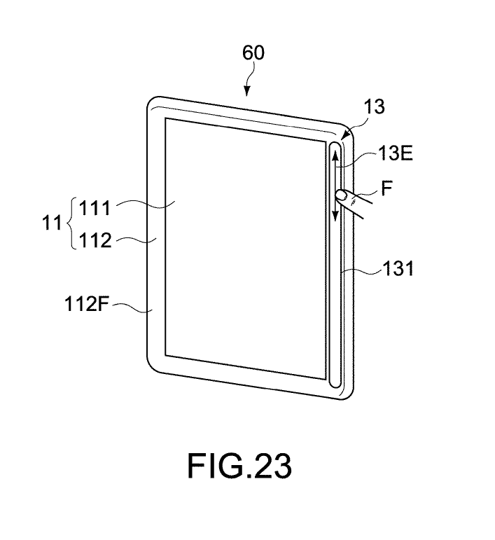

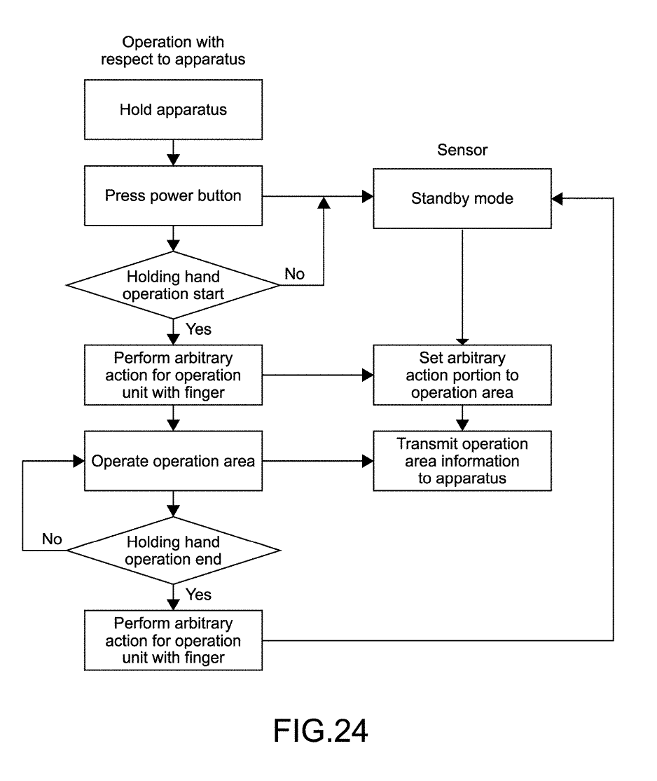

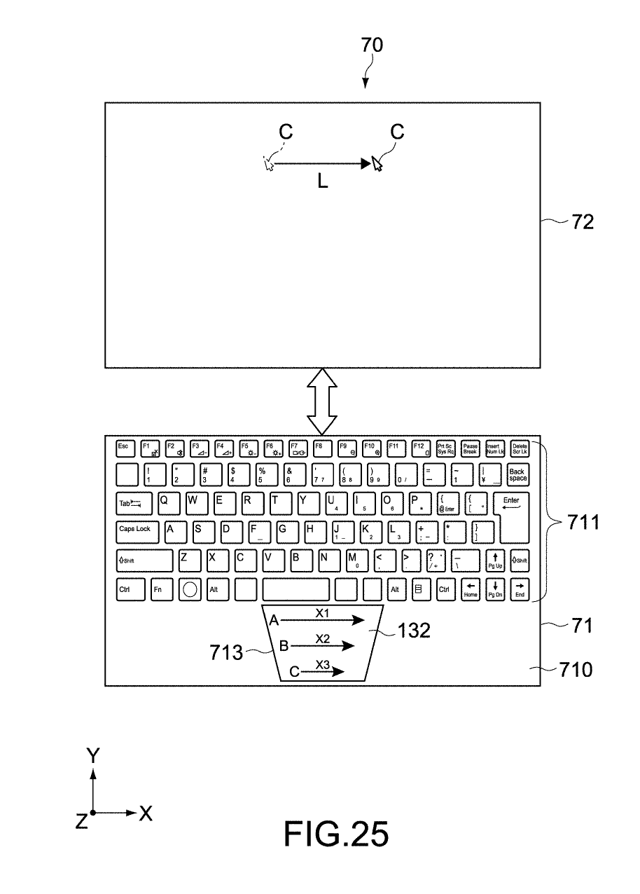

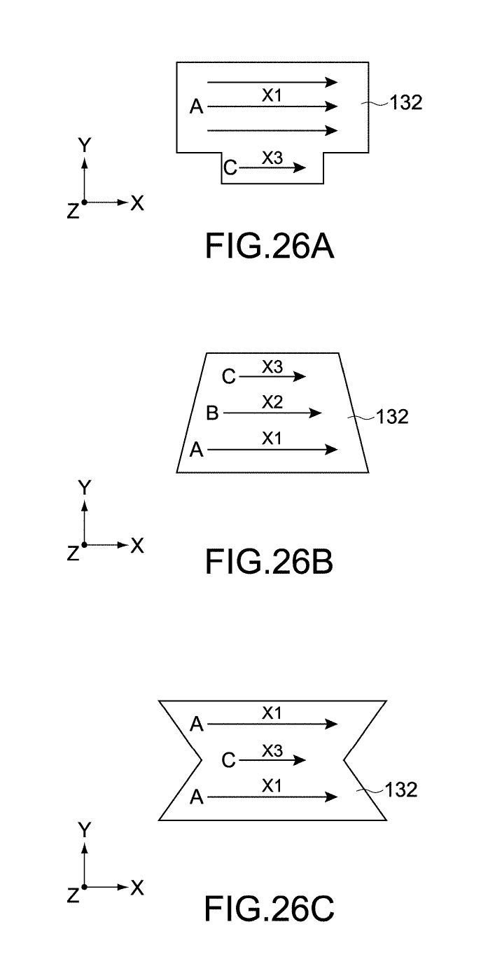

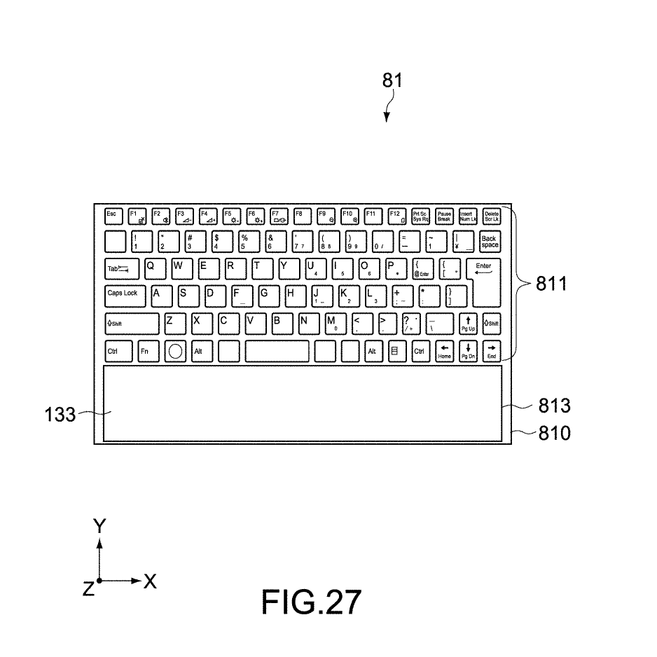

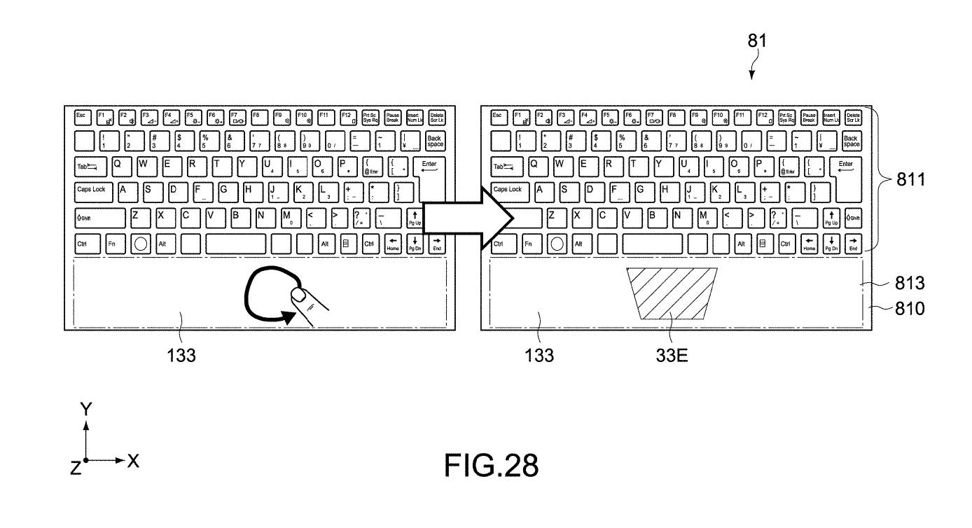

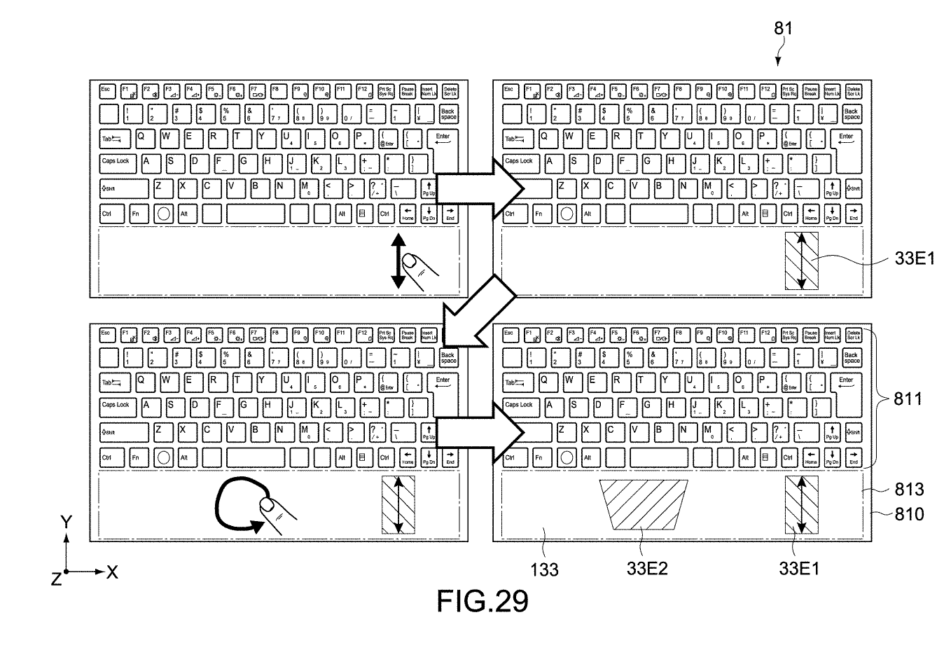

### BRIEF DESCRIPTION OF DRAWINGS

[FIG. 1] A schematic overall perspective view showing an information processing apparatus according to an embodiment of the present technology.

[FIG. 2] A block diagram showing a configuration of the information processing apparatus.

[FIG. 3] A schematic overall perspective view showing another configuration example of the information processing apparatus.

[FIG. 4] A schematic overall perspective view showing another configuration example of the information processing apparatus.

[FIG. 5] A schematic overall perspective view showing another configuration example of the information processing apparatus.

[FIG. 6] A main part cross-sectional view of a detection area in the information processing apparatus.

[FIG. 7] A schematic plan view showing a typical sensor layout of a capacitance device disposed on the detection area.

[FIG. 8] A schematic plan view showing another configuration example of the sensor layout.

[FIG. 9] A diagram for explaining an operation of a detection unit having the sensor layout shown in FIG. 8.

[FIG. 10] A schematic plan view showing another configuration example of the sensor layout.

[FIG. 11] A schematic plan view showing another configuration example of the sensor layout.

[FIG. 12] A schematic plan view showing another configuration example of the sensor layout.

[FIG. 13A] An enlarged view showing a main part for explaining an operation example of the information processing apparatus shown in FIG. 5.

[FIG. 13B] An enlarged view showing a main part for explaining another operation example of the information processing apparatus shown in FIG. 5.

[FIG. 14] A graph showing a typical capacitance change curve of the capacitance device with respect to an operation load input to the detection area.

[FIG. 15] An explanatory diagram showing a relationship between a pressing operation force and a pressing area when an operation surface is flat.

[FIG. 16] An explanatory diagram showing a relationship between the pressing operation force and the pressing area when a protrusion is given to the operation surface.

[FIG. 17A] A side view schematically showing a state of deformation of the operation surface at a time when a concentrated load is applied to the operation surface.

[FIG. 17B] A side view schematically showing a state of deformation of the operation surface at a time when a distributed load is applied to the operation surface.

[FIG. 18] A diagram showing a relationship between the operation load and a capacitance change on the operation surface shown in FIG. 16.

[FIG. 19A] A side view schematically showing an example of a structure given to the operation surface.

[FIG. 19B] A plan view schematically showing an example of a structure given to the operation surface.

[FIG. 20A] A schematic side view showing an input example with respect to the operation surface to which the structure shown in FIG. 19A is given.

[FIG. 20B] A schematic side view showing another input example with respect to the operation surface to which the structure shown in FIG. 19A is given.

[FIG. 20C] A schematic side view showing another input example with respect to the operation surface to which the structure shown in FIG. 19A is given.

[FIG. 21A] A side view schematically showing another configuration example of the structure given to the operation surface.

[FIG. 21B] A side view schematically showing another configuration example of the structure given to the operation surface.

[FIG. 21C] A side view schematically showing another configuration example of the structure given to the operation surface.

[FIG. 22] A schematic overall perspective view showing a modified example of a configuration of the information processing apparatus shown in FIG. 1.

[FIG. 23] A schematic overall perspective view showing a modified example of a configuration of the information processing apparatus shown in FIG. 3.

[FIG. 24] A flowchart showing an operation example of the information processing apparatus shown in FIG. 23.

[FIG. 25] A schematic configuration diagram showing an information processing apparatus according to a second embodiment of the present technology.

[FIG. 26A] A schematic plan view showing a modified example of a configuration of a detection area shown in FIG. 25.

[FIG. 26B] A schematic plan view showing another modified example of a configuration of the detection area shown in FIG. 25.

[FIG. 26C] A schematic plan view showing another modified example of a configuration of the detection area shown in FIG. 25.

[FIG. 27] A schematic plan view showing an input apparatus according to a third embodiment of the present technology.

[FIG. 28] A schematic plan view for explaining an operation method of an input apparatus shown in FIG. 27.

[FIG. 29] A schematic plan view for explaining another operation method of the input apparatus shown in FIG. 27.

### MODE(S) FOR CARRYING OUT THE INVENTION

Hereinafter, embodiments according to the present technology will be described with reference to the drawings.

### First Embodiment

FIG. 1 is a schematic overall perspective view showing an information processing apparatus according to an embodiment of the present technology. In the figure, an X axis, an Y axis, and a Z axis indicate three axis directions that are orthogonal to one another (the same holds true for the following figures).

[Configuration of Information Processing Apparatus]
An information processing apparatus 10 in this embodiment is configured by a slate mobile information terminal such as a smart phone and a tablet PC (Personal Computer).

(Main Body)
The information processing apparatus 10 includes a main body 11. The main body 11 has such a size that a user can operate the main body 11 with the main body 11 held, and has a substantially rectangular plate shape with a Z axis direction as a thickness direction.

The main body 11 includes a display unit 111 and a casing unit 112 that supports the display unit 111.

Typically, the display unit 111 is configured by a display apparatus provided with a touch panel. The display apparatus is configured by various display devices such as a liquid crystal display device and an organic electro-luminescence device. Typically, the touch panel is disposed on a screen of the display apparatus. The touch panel is configured by a capacitive touch sensor that detects a touching operation for the display unit 111 but is not limited to this. The touch panel may be configured by a resistance film type touch sensor or a touch sensor with another detection method.

The casing unit 112 is configured so as to cover a periphery and a back surface of the display unit 111 and forms an outer shape of the main body 10. Typically, the casing unit 112 is configured by a synthetic resin material, a metal material, or a composite of those (or laminated body). On the casing unit 112, various switches such as a power supply button are disposed, and in the casing unit 112, a control unit that controls an operation of the information processing apparatus 10, a battery, and the like are stored, as will be described later.

FIG. 2 is a block diagram showing a configuration of the information processing apparatus 10.

The information processing apparatus 10 includes the display unit 111, a CPU (Central Processing Unit) 113, a memory 114, a wide area communication unit 115, a local area communication unit 116, various sensors 117 including a motion sensor and a camera, a GPS (Global Positioning System) reception unit 118, an audio device unit 119, a battery 120, and the like.

The wide area communication unit 115 can perform communication by a communication system such as 3G (Third Generation) and LTE (Long Term Evolution), for example. The local area communication unit 116 can perform communication by a wireless LAN (Local Area Network) communication system such as WiFi and/or a short-range wireless communication system such as Bluetooth (registered trademark) and infrared rays. The information processing apparatus 10 may include an individual recognition device that uses a so-called short-range wireless communication system such as RFID (Radio Frequency IDntification), separately from the local area communication unit 116. The audio device unit 119 includes a microphone and a speaker.

The display unit 111 functions as an output apparatus that displays various pieces of information and also functions as an input apparatus for an operation of the information processing apparatus 100, a character input, a cursor operation, an operation of application software, and the like.

Here, in the slate information processing apparatus having the display apparatus in which input and output functions are incorporated, a part of the display screen is hidden by a hand or a finger in operation. This hinders visual confirmation of output information at a time of the operation. On the other hand, when an input operation area on the screen is reduced to secure visual confirmation of the output information, degradation of the operability is inevitable.

In view of this, the information processing apparatus 10 according to this embodiment further includes a pressing force detection unit 13 that makes it possible to perform an input operation without touching the display unit 111. When the display unit 111 (touch panel) is considered as a first input operation unit, the pressing force detection unit 13 functions as a second input operation unit. Hereinafter, the pressing force detection unit 13 will be described in detail.

(Pressing Force Detection Unit)
The pressing force detection unit 13 includes a detection area 131 provided on a surface of the casing unit 112 and can electrostatically detect a pressing force to the detection area 131. Further, the pressing force detection unit 13 can electrostatically detect a pressing input position in the detection area 131 and a change thereof.

The detection area 131 is provided on a frame-shaped portion 112F of the casing unit 112 disposed around the display unit 111 on a front surface of the main body 11, for example. In the example of FIG. 1, in one area of a long side portion that is close to a corner portion on an upper right of the main body 11, the detection area 131 is provided.

The position of the detection area 131 and the number thereof on the frame-shaped portion 112F are not limited to the example shown in FIG. 1, and can be appropriately set in accordance with a position where the user holds the main body 11, a posture of the main body 11 (vertically oriented or horizontally oriented), or the like. For example, like an information processing apparatus 20 shown in FIG. 3, the detection area 131 may be set on a substantially entire area of the one long side portion of the frame-shaped portion 112F. Like an information processing apparatus 30 shown in FIG. 4, the detection area 131 may be set on each of long side portions of the frame-shaped portion 112F. It should be noted that the position of the detection area 131 is not limited to the long side portions of the frame-shaped portion 112F but may be provided on short side portions or on both of those.

On the other hand, the surface of the casing unit 112 on which the detection area 131 is provided is not limited to the frame-shaped portion of the casing unit 112 but may be an entire area of a back surface of the main body 11 on an opposite side to the display unit 111 or a partial area thereof. For example, FIG. 5 shows a configuration example of an information processing apparatus 40 in which the detection area 131 is provided in the vicinity of a corner portion of a back surface 112B of the casing unit 112. With this configuration, it is possible to perform a pressing input operation with respect to the information processing apparatus 40 with a hand and a finger on a side on which the user holds the main body 11.

FIG. 6 is a main part cross-sectional view showing a configuration example of the pressing force detection unit 13. The pressing force detection unit 13 is constituted of a laminated body of a sensor sheet 310 having a plurality of capacitance devices 13s disposed in an XY plane (detection area 131) in a matrix pattern, a flexible sheet 320 having an input operation surface 321, a support layer 330, and a base layer 350.

The flexible sheet 320 is made of an insulation plastic film having flexibility such as a PET (polyethylene terephthalate) film. An outer surface thereof is configured as the input operation surface 321. On an inner surface of the flexible sheet 320 opposite to the input operation surface 321, a deformable conductive layer 322 that faces the plurality of capacitance devices 13s is disposed. Typically, the conductive layer 322 is connected to a ground potential and is fixed to the inner surface of the flexible sheet 320 through an adhesive layer, for example.

The sensor sheet 310 includes a plurality of first electrode lines 311 extended in a Y axis direction and arranged in an X axis direction at intervals and a plurality of second electrode lines 312 extended in the X axis direction and arranged in the Y axis direction at intervals. The plurality of capacitance devices 13s is configured by intersection portions of the plurality of first and second electrode lines 311 and 312 and functions as sensors capable of detecting capacitances at the intersection portions.

Typically, the sensor sheet 310 is configured by mutually laminating a deformable insulation plastic film that supports the first electrode lines 311 and a deformable insulation plastic film that supports the second electrode lines 312 through an adhesive layer. The plurality of capacitance devices 13s is connected to an oscillation circuit (not shown), and in the CPU 113 (or a signal processing circuit dedicated thereto), respective capacitances of the plurality of capacitance devices 13s are individually calculated.

The support layer 330 is disposed between the sensor sheet 310 and the flexible sheet 320, and elastically supports the input operation surface 321 with respect to the sensor sheet 310. The support layer 330 includes a plurality of structures 331 disposed between the sensor sheet 310 and the flexible sheet 320 and a space portion 332 formed between the plurality of structures 331. The plurality of structures 331 is typically made of a material that can be elastically deformed in the thickness direction (Z axis direction). The plurality of structures 331 is disposed immediately above the capacitance elements 13s but is not of course limited to this.

The base layer 340 is configured by an insulation plastic film. The base layer 340 is used as a base for fixing the sensor sheet 310 to the casing unit 112 but can be omitted as necessary.

With the pressing force detection unit 13 configured as described above, on a basis of the capacitance of the capacitance elements 13s which changes depending on a distance between the conductive layer 322 and the sensor sheet 310 due to an input operation on the input operation surface 321, a pressing force to the input operation surface 321 can be detected. Further, when a finger is moved in parallel to the XY plane while an operation load is applied, a deformation state of the input operation surface is shifted while following the operation position. As a result, it is possible to detect coordinates of the position where the input operation is performed or a change thereof and a load applied to the position.

(Control Unit)
The information processing apparatus 10 further includes a control unit 14 (FIG. 2) configured to control an image displayed on the display unit 111 on a basis of a pressing input operation in the detection area 131 and a motion thereof. In this embodiment, the control unit 14 is constituted of the CPU 113, the memory 114, and the like but may be configured by a dedicated control unit.

On a basis of an output of the pressing force detection unit 13, the control unit 14 can detect a pressing operation position with a finger on the detection area 131, an operation load, and a motion speed of the finger. When the operation load is applied, the control unit 14 may calculate a center of gravity of the operation position on a basis of a capacitance change amount of the plurality of capacitance devices 13s provided in the vicinity thereof. Further, a plurality of input switches may be assigned to the detection area 131, and in accordance with a layout of the switches, the capacitance elements 13s may be arranged.

Examples of the input operation with respect to the detection area 131 include a pointing operation by moving a finger, a screen scroll, switching control or the like for a screen size, a sound volume, a screen brightness, a video fast forward (reverse) in accordance with a pressing load. This can be set as appropriate in accordance with a kind of application.

[Operation of Information Processing Apparatus]
As described above, in the tablet terminal in which input and output functions are incorporated in the display apparatus, principally, a part to be operated is hidden with a finger used to perform the operation, so an area of a fingertip for the operation imposes a limitation, with the result that it is difficult to perform a delicate operation. Further, in a case where a text input is performed, generally, a software keyboard is displayed on a screen and operated by being touched with fingers. It is necessary to display the software keyboard in the screen, which results in a reduction in area for an output. As described above, in the case where the input and output functions are incorporated in the display apparatus, in such a situation that a desired area is necessary to perform the input operation, such a problem that a display area to obtain output information by a user arises.

Further, in the tablet terminal of this type, when the display screen is set to be larger, a motion for performing the operation becomes also larger. For example, in a case of a screen size of approximately 4 inches, it is possible to perform a one-hand operation of touching a screen with a thumb or the like while holding an apparatus. However, as the screen size is increased, imaginably, the finger does not get thereto. By using a mouse or a touch pad, the operation can be performed basically for a large screen in a small operation area, but the operation to the touch panel on the screen is an operation depending on the screen size.

In contrast, in the information processing apparatus 10 in this embodiment, not only by the input operation to the display unit 111 having the touch panel but also by the pressing input operation to the detection area 131, display control or the like for an image displayed on the display unit 111 can be performed. As a result, displaying an image can be controlled without operating the display unit 111 directly with a finger, so the operability can be improved. Further, visual confirmation of output information at a time of the operation is improved, and a sufficient display area for obtaining the output information is secured.

Further, because the detection area 131 (pressing force detection unit 13) can function as a touch pad, a pointing operation can be performed by a moving a finger in the detection area 131. Thus, even in a case where the screen size is large, a moving area of the finger for the operation is reduced. As a result, a large motion for the operation becomes unnecessary, which can improve the operability and reduce a feeling of fatigue. Further, when the detection area 131 is provided in the vicinity of the holding portion of the main body 11, a one-hand operation can be achieved while the main body is held.

Further, in this embodiment, the pressing force detection unit 13 can detect the pressing force of the detection area 131. Therefore, as compared to an input device that can perform only a binary input of on and off like the touch panel on the display unit 111, input operability is expanded, and even by a single pressing operation, various image display control depending on pressing loads can be achieved. In addition, it is possible to determine presence or absence of the input operation depending on a degree of the pressing force. As a result, it is possible to avoid an input operation that is not intended by a user (that is, erroneous operation).

[Details of Respective Units]
The information processing apparatus 10 in this embodiment can achieve further improvement of the operability by being configured as follows.

1. Layout of Capacitance Devices
FIG. 7 is a schematic plan view showing a typical arrangement example of the plurality of capacitance devices 13s (sensors) on the sensor sheet 310. It should be noted that, for ease of understanding, the capacitance elements 13s are indicated by white circles (the same holds true for FIG. 8 to FIG. 12).

In the arrangement example shown in FIG. 7, the capacitance elements 13s are arranged in the X axis direction and the Y axis direction at a regular interval. In this sensor layout, a shift amount of a finger along the two axis directions of X and Y directions on the detection area 131 and an actual operation shift amount are equal to each other.

On the other hand, the capacitance elements 13s shown in FIG. 8 are arranged at a regular interval in the X axis direction, but in the Y axis direction, the capacitance elements 13s are arranged in such a manner that intervals of those are increased as Y coordinates becomes larger. In this sensor layout, a concept of a calculation result for an operation distance of the finger on the detection area 131 is as shown in FIG. 9.

As shown in FIG. 9, the actual operation shift amount with respect to the finger shift amount differs depending on a difference in the sensor interval. In the example of FIG. 9, for example, in the case where a cursor on the screen is moved, to achieve a shift of the same amount, as the coordinates in the Y axis direction is increased, the finger operation shift amount is increased. Conversely, as the coordinates in the Y axis direction is reduced, the cursor can be moved with a smaller finger shift. With this sensor layout, on a basis of an ease of a finger motion obtained from an analysis of an assumed finger operation, for example, a sensor pitch is set to be small in an area where the finger is difficult to be moved, with the result that the operation can be performed comfortably with a small motion.

It should be noted that the adjustment of the operation shift amount based on devising the sensor layout as described above may be achieved by adding correction to the calculation result even when the sensor layout shown in FIG. 7 is used. However, an advantage of devising the sensor layout shown in FIG. 8 and FIG. 9 resides in such a point that detection accuracy of the sensor can also be improved by reducing the sensor pitch in the area where the small motion is necessary. In a sensor that performs a gravity center calculation generally, there is a large correlation between a sensor pitch and detection accuracy/detection resolution. As the sensor pitch is reduced, higher accuracy and higher resolution are obtained. By changing the sensor pitch, it is possible to achieve a sensor characteristic in accordance with the finger shift amount.

Other layout examples in which the sensor pitches are different are shown in FIG. 10 to FIG. 12. FIG. 10 shows a sensor layout in which pitches in the two axis directions of X and Y directions are not equal to one another. FIG. 11 shows a sensor layout in which an operation area in one axis direction is changed. The sensor pitch is not limited to the example of the monotonous increase along with the increase of the coordinates. For example, as shown in FIG. 12, in the X axis direction, the sensor pitch is increased monotonously, while in the Y axis direction, a composite sensor pitch having an increase and a decrease thereof.

In the sensor layout shown in FIG. 8 to FIG. 12 as described above, the plurality of capacitance devices 13s has a plurality of device columns whose arrangement intervals along at least one direction are different from one another. The one direction is, typically, an axis direction such as the X axis direction and/or Y axis direction, but is not limited to this. The one direction may be a concentric circumferential direction. With this configuration, depending on the device columns, the number of devices that detect the finger motion along the one direction is different. Thus, for example, in a pointing operation of an image displayed on the display unit 111, it is possible to make the cursor shift amount on the display unit different for each device column. As a result, for example, it is possible to improve the pointing operability in an area where a finger movable range is limited.

For example, as shown in FIGS. 13A and 13B, the information processing apparatus 40 (see, FIG. 5) in which the detection area 131 is set in a partial area on a back surface (back surface of casing portion) 112B of the main body 11 is considered. In this example, as described above, in the vicinity (in the vicinity of a corner portion of the back surface 112B) of the holding portion of the main body 11 held by the user, the detection area 131 is provided, the detection area 131 is operated with a thumb of a hand that holds the main body 11.

As shown in FIG. 13A, in the case where an area away from the holding portion is operated, it is possible to operate a broad area relatively easily with the thumb extended. In contrast, as shown in FIG. 13B, in the case where an area close to the holding portion is operated, the thumb has to be bent, leading to a cramped operation and a reduction in movable range thereof. In view of this, by configuring the detection area 131 with the fan-like sensor layout as shown in FIG. 11, for example, the device columns are provided in such a manner that the sensor arrangement intervals are smaller, as the sensors are closer to the holding portion. As a result, while maintaining the operability in the area away from the holding portion, the sensor pitch is reduced in the area close to the holding portion, with the result that desired operability can be secured. The sensor layout is coordinated with a natural motion range of the finger as described above, and thus further improvement of the operability at a time of the one-hand operation can be achieved.

2. Sensitivity of Capacitance Device
By giving a predetermined shape to a predetermined operation area in the detection area 131, a capacitance change curve with respect to a load is controlled, and sensitivity to the capacitance change with respect to a motion of a finger is variably adjusted.

FIG. 14 is a typical graph showing a relationship between a pressing load and the capacitance change of the sensors (capacitance elements 13s). Deformation is caused by a flexural rigidity or the like of the input operation surface 321 (flexible sheet 320) and the support layer 330, so a capacitance change curve as shown in FIG. 14 is obtained. The capacitance change amount is decreased as the load is increased, leading to saturation.

For example, as shown in FIG. 15, when a finger is pressed to an operation surface S1 increasingly strongly, it is easily imaginable that, along with an increase in the load with respect to the operation surface S1, the finger is deformed. In a viewpoint of a change in load distribution applied to a deformation structure with respect to the operation load, as can be seen from FIG. 15, as the operation load is increased, a load area is also increased. That is, along with the increase in the operation load, the concentrated load is changed to the distributed load.

On the other hand, as shown in FIG. 16, by providing a protrusion S2 having an arbitrary shape on the operation surface S1, it is possible to generate a characteristic change of a contact surface with respect to a motion of a fingertip or a load. When the protrusion S2 smaller than a contact area of the finger is given to the operation surface S1, in the case where deformation of the finger is less than a height of the protrusion S2 at a time when the finger pressed thereto, a load area with respect to the operation surface S1 is not changed, and only the load is increased. When the amount of deformation of the finger is equal to or more than the height of the protrusion S2, a part of the finger is brought into contact with not only the protrusion S2 but also the operation surface S1, and thus the load is applied to the operation surface S1.

By giving the three-dimensional structure as described above to the operation area in the detection area 131, the shape of the deformation of the operation surface can be changed. An example thereof is shown in FIGS. 17A and 17B. A deformation posture at a time when the concentrated load is applied to the operation surface S1 is as shown in FIG. 17A. A deformation posture at a time when the distributed load is applied thereto is as shown in FIG. 17B. When FIGS. 17A and 17B are compared to each other, the case of FIG. 17B shows a larger capacitance change amount. This is because in the case of the distributed load, the deformation posture of the operation surface S1 is flatter as compared to the case of the concentrated load, and a total of changes in electrode distance with respect to the sensor is increased. Therefore, by giving the three-dimensional structure such as the protrusion S2 as described above to the operation surface S1, it is possible to obtain a curve of the load/capacitance change as shown in FIG. 18, for example. In this case, for example, a threshold value for binary determination of on and off is easily set, which is advantageous to robustness.

Further, as shown in FIGS. 19A and 19B, a structure S3 constituted of a plurality of protrusions can be provided on the operation surface S1. The structure S3 is typically constituted of the plurality of protrusions which is formed in a distributed manner over a wider range than an area of a fingertip in contact with the operation surface S1. In this case, as shown in FIGS. 20A to 20C, in accordance with a tilt of the fingertip, a change in distribution of a deformation load applied to the operation surface S1 is increased, with the result that sensitivity of the capacitance change with respect to an angle of the fingertip can be increased.

That is, in the case where the load is vertically applied to the operation surface S1, as shown in FIG. 20A, a maximum load is applied to the center portion of a contact position. Meanwhile, when the finger is tilted forwards or backwards (or leftwards or rightwards), the position of the maximum load is changed in the tilted direction. By using this feature, it is possible to perform a scroll operation for a screen without shifting the finger, for example, or, to give a function like a jog dial to the operation area. As a result, more instinctive operability can be obtained.

The shape of the three-dimensional structure given to the operation surface S1 is not particularly limited. For example, as shown in FIGS. 21A to 21C, in accordance with an operation touch, operation sensitivity desired to be detected, a resolution, or the like, various shapes can be applied. FIG. 21A shows an example in which a substantially dome-shaped projected portion S4 is given onto the operation surface S1. FIG. 21B shows an example in which a relatively shallow depressed portion S5 is given onto the operation surface S1. Further, FIG. 21C shows an example in which a three-dimensional structure S6 obtained by combining the projected portion S4 and the depressed portion S5 is given thereto. The structure is not limited to a single structure. As shown in FIGS. 19A and 19B, a plurality of structures may of course be disposed two-dimensionally.

3. Location of Detection Area
Subsequently, regarding a method of detecting only an operation of a user, an idea thereof will be described as follows.

The detection area 131 (pressing force detection unit 13) described above can be provided on various positions. However, depending on a provided position, an operation that is not intended by the user may be detected, and there is a fear that the operability may be impaired. In a case of a general touch sensor, an erroneous detection may be caused only by touching. However, with the configuration of the pressing force detection unit 13 described above, the operation load is necessary to some extent, so a possibility of an erroneous detection is lower than a general touch sensor.

On the other hand, when a detection operation load is too large, an operation feeling is impaired. It is known that even when operating a general touch panel, a user applies a load of approximately 20 gf. In order to achieve a light operation as in a touch panel, it is necessary to detect an operation load of approximately 20 gf, which may cause an erroneous detection with respect to an unintended small force.

For example, in this embodiment, in the case where the detection area 131 is provided on the frame-shaped portion 112F or the back surface 112B of the casing unit 112, when a hand with which the main body 11 is held is brought into contact with the detection area 131, there is a fear that a load of 20 gf may be applied to a detection surface. Because a weight of the main body 11 is several hundred grams or more, to a hand that holds the main body or a palm thereof, a load of several tens of gf or more. As a method of preventing the erroneous detection as described above, the following methods can be combined.

For example, an information processing apparatus 50 shown in FIG. 22 gives the detection area 131 a structure 13p having a three-dimensional shape. As a result, it is possible for a user to specify the position of the detection area 131 visually or in a tactile manner, which can lead to a prevention of holding the area to which the shape is given. Further, the area to which the structure 13p is given is set as a detection area, so it is unnecessary to provide a clear boundary of the detection area, with the result that an advantageous design can be achieved.

It should be noted that the structure 13p may have similar functions to the structures S2 to S6 as described above. As a result, with the shape or size of the structure, or the like, it is possible to adjust detection sensitivity with respect to a pressing input operation in the detection area.

As another method, setting the detection area 131 to a part other than the holding hand is conceived. For example, when a use state of the user is assumed, a lower side of the main body 11 is held in many cases. In this case, it is sufficient that the detection area 131 is provided on an upper side of the apparatus. Further, this method and the method of giving the shape may be combined, which can further reduce a possibility of an occurrence of the erroneous operation.

4. Selection Setting of Operation Area
In the configuration example as shown in FIG. 22, it is necessary to decrease the size of the detection area 131 itself. In contrast, for example, in a case where comfortable operability is desired to be secured with respect to various ways of holding, as shown in FIG. 3 and FIG. 4, it is necessary to increase the size of the detection area 131. In this way, when the detection area 131 is increased, a degree of freedom of the operation is increased because the user can hold the apparatus on a lower side or an upper side thereof, but a possibility of an occurrence of an erroneous detection is increased erroneous detection.

To solve this problem, it is effective that the detection area is set to be large in advance, and a predetermined area of the detection area is selected as an operation area where the operation is valid by a selection operation by the user. An outline thereof is shown in FIG. 23. An information processing apparatus 60 shown in the figure includes the detection area 131 disposed on an entire area of a long side portion of the frame-shaped portion 112F of the casing 112. The user inputs a predetermined gesture operation for the predetermined area of the detection area 131, thereby setting the predetermined area as an operation valid area 13E and setting an area excluding the predetermined area as an operation invalid area. As a result, only the area intended by the user is reset as the valid detection area, so a possibility of an occurrence of an erroneous operation is markedly slim.

To achieve the function as described above, the control unit 14 (FIG. 2) is configured to be capable of setting a part of the detection area 131 as the operation area where a pressing input operation is valid by the selection operation by the user immediately after a power is turned on, for example. The selection operation is not particularly limited. In the information processing apparatus 60 shown in FIG. 23, such an operation is performed that a partial area (upper area in the example shown in the figure) of the detection area 131 extended in a long-side direction along the frame-shaped portion 112F is traced with a finger F one or several times.

At this time, the control unit 14 electrostatically detects a motion of the pressing input operation in the detection area 131 through the pressing force detection unit 13, and sets an operation area of the pressing input operation in the detection area 131 is set as an operation area (operation valid area 13E) where the input operation is valid. After the operation area is set, the control unit 14 controls an image displayed on the display unit 111 on a basis of the pressing input operation in the set operation area and a motion thereof.

To achieve the control as described above, the control unit 14 executes the following software (program). The software causes the following steps to be performed. That is, the steps include a step of electrostatically detecting the motion of the pressing input operation in the detection area 131 provided on the surface of the casing unit 112, a step of setting the operation area of the pressing input operation in the detection area 131 as the operation area where the input operation is valid, and a step of controlling the image displayed on the display unit 111 on the basis of the pressing input operation in the operation area and the motion thereof. The operation of the information processing apparatus 60 is performed in cooperation with the CPU 113 (FIG. 2) and the software executed under the control thereof. The software is stored in the memory 114 (FIG. 2), for example.

Hereinafter, typical operation examples using the software will be described.

(Case 1)
In this case, at a time when the user holds the apparatus, the operation area is set on a position where the user wants to operate. This is similar to a gesture operation of a kind of unlocking. When such algorism that only the position is set as the operation area (operation valid area 13E) in accordance with a decision by the user is used, after that, even if a finger is in contact with a part excluding the operation area, there is no fear that the erroneous detection occurs. In this case, the control unit 14 may be configured so as not to perform sensing for the pressing input operation in the area excluding the operation area. As a result, it is possible to achieve a reduction of power consumption of the control unit 14, an improvement of a detection speed, and the like. Instead, the control unit 14 may perform a process of sensing the pressing input operation in the area excluding the operation area and setting the pressing input operation for the area to be invalid.

(Case 2)
For example, in a case where the user changes the posture (vertical or horizontal orientation) of the apparatus or changes hands for holding the apparatus, it is thought that this may lead to changing of the holding portion of the main body 11. If the operation area can be changed, it is advantageous in terms of an improvement of the operability. Specifically, for example, on an area to which the user wants to change the operation area, for example, a predetermined operation such as “long pressing” and “double tap” for a predetermined period, thereby newly setting the operation area to that area. In this case, this is predicated on sensing of the pressing input operation on an area excluding the operation area by the control unit 14.

(Case 3)
Depending on a kind of application software, for example, such an operation that on and off is desired to be performed quickly, such an operation that scrolling of a screen is performed by tracing vertically, or the like are desired to be switched within the same operation area. In this case, it is desirable that, depending on the kind of started application software, an operation method with respect to the operation area be automatically switched, or an operation method be switched by detecting an arbitrary input operation by the user. Instinctively, it is conceived that a tap-like operation causes a change into a switch, and several vertical stroking operations cause switching to a vertical gesture ready sensor, for example.

(Case 4)
When the area (holding portion) held by the user is detected, and the operation area is automatically set in the vicinity thereof, it is possible to achieve a one-hand operation without being aware of the operation area. In this case, for example, in a substantially entire area of the back surface 112B of the casing unit 112, the detection area 131 is provided. The control unit 14 detects an area corresponding to the holding portion from the detection area 131. After that, the control unit 14 detects an area to be subjected to the pressing operation with a finger of the holding hand of the user, and sets the detected area as the operation area. As a result, on a desired position within the detection area, the operation area can be set. Thus, it is possible to provide the operability that does not depend on the position of the holding hand of the user who holds the main body and the posture of the main body.

FIG. 24 is a flowchart showing an example of a setting procedure of the operation area. Typically, a power is turned on in a state in which the user holds the apparatus with one hand. At this time, the control unit 14 is shifted to a standby mode, and determines an area that can be regarded as the holding portion on a basis of a load distribution in the detection area immediately after the power is turned on. When the user starts a holding hand operation, on a basis of a pressing input operation of an arbitrary area excluding the holding portion and a motion thereof, the control unit 14 sets the arbitrary area as the operation area where the input operation is valid, and after that, performs display control for the screen on the basis of the pressing input operation in the operation area.

On the other hand, in a case where the user stops using, changes holding hands, or changes the holding position, by detecting a predetermined action input to the operation area, the control unit 14 is shifted to the standby mode again. At this time, the control unit 14 performs the detection process of the holding portion again. It should be noted that the control unit 14 may performs the standby mode with a loss of the pressing force input to the holding portion as a starting point.

For example, as shown in FIG. 4, this case can also be applied to a case where the detection area 131 is provided on the frame-shaped portion 112F of the casing unit 112. Further, this case can also be applied to not only a case of setting the operation area at a time of the one-hand operation but also a case where the main body 11 is held with one hand, and the operation area is operated with the other hand.

### Second Embodiment

FIG. 25 is a schematic configuration diagram of an information processing apparatus according to another embodiment of the present technology. An information processing apparatus 70 according to this embodiment includes an operation member 71 as an input apparatus, a display unit 72, and a control unit. The operation member 71 and the display unit 72 are electrically connected with each other, and an output with respect to an input operation of the operation member 71 is displayed on the display unit 72.

The information processing apparatus 70 may be configured by a clamshell-type laptop PC in which the operation member 71 and the display unit 72 are electrically and mechanically connected with each other, or may be configured by a desktop information processing apparatus in which the operation member 71 and the display unit 72 are separated.

The operation member 71 has a key input unit 711 having a plurality of input keys and a pressing force detection unit 713 capable of electrostatically detecting the pressing force and having the detection area 132. On a basis of the pressing input operation in the detection area 132 and a motion thereof, the control unit controls an image displayed on the display unit 72. The control unit has a configuration similar to the control unit 14 described in the first embodiment, and may be incorporated in the operation member 71 or may be configured separately from the operation member 71.

The operation member 71 further includes a substantially rectangular plate-like main body 710, and the key input unit 711 and the pressing force detection unit 713 are disposed on the same surface of the main body 710. The key input unit 711 has a function as a keyboard, and the pressing force detection unit 713 has a function as a touch pad. The pressing force detection unit 713 is disposed in front of the key input unit 711 when viewed from a user side, but the position is not limited to this. The position of the pressing force detection unit 713 can be set in an area excluding the position described above as appropriate.

The pressing force detection unit 713 has a configuration similar to the pressing force detection unit 13 (FIG. 6) described in the first embodiment, so a detailed description thereof will be omitted. The detection area 132 is an area where a pressing input can be performed with a hand or a finger of the user. In the area, a plurality of sensors (capacitance elements 13s) described in the first embodiment is arranged in a matrix pattern.

A planar shape of the detection area 132 is not particularly limited, and typically, the detection area 132 is formed into a polygonal shape such as a rectangle. In this embodiment, as shown in FIG. 25, the detection area 132 is formed into an inverted trapezoid having an upper base longer than a lower base. Further, the plurality of capacitance devices 13s disposed in the detection area 132 has the fan-like sensor layout as shown in FIG. 11 in which a pitch along the X axis direction is narrower on the lower base side of the detection area 132 than the upper base side thereof.

The information processing apparatus 70 in this embodiment is provided with the control unit that controls the image displayed on the display unit 72 on the basis of the pressing input operation in the detection area 132 provided to the operation member 71 and the motion thereof. Here, the control unit electrostatically detects the pressing force in the detection area 132, and thus can detect various input operations by the user by performing comprehensive judgment for not only a binary input of on and off but also a degree of a pressure or the like at a time of on. As a result, it is possible to provide the operability fitted to an intention of the user.

Further, the plurality of capacitance devices 13s arranged in the detection area 132 in the matrix pattern has a plurality of device columns (A, B, C, . . . ) arrangement intervals of which are different from each other along the X axis direction. The plurality of device columns is provided so as to correspond to areas whose widths along the X axis direction of the detection area 132 are different from each other. As a result, depending on the device column, a number of devices that detect a shift of a finger along the X axis direction differs. Thus, for example, in a pointing operation of an image displayed on the display unit 72, it is possible to make a shift amount of a cursor in the display unit 72 different.

For example, as shown in FIG. 25, in a case where a cursor C displayed on the display unit 72 is shifted along the X axis direction by a distance L, a shift amount of a finger necessary for the operation differs depending on an operation position of the detection area 132. In this embodiment, in an order of device columns A, B, C, a motion distance (X1, X2, X3) of the finger is shortened. Therefore, by shifting the finger along a lower portion of the detection area 132, a long cursor shift can be achieved by a small motion amount of the finger, while by shifting the finger along an upper portion of the detection area 132, a delicate cursor shift can be achieved.

As described above, a cursor shift speed can be selected in the same detection area 132, so pointing operability can be improved. Further, Because the detection area 132 is formed into the inverted trapezoid, it is possible to cause the user to sense areas where the cursor shift speeds are different in a visual and tactile manner.

The shape of the detection area 132 is not limited to the example described above, and may have shapes shown in FIGS. 26A to 26C, for example. Also in the detection area 132 shown in FIGS. 26A to 26C, a plurality of device columns whose arrangement intervals along the X axis direction are different from each other is arranged in the Y axis direction. The arrangement form of the device columns is not particularly limited. For example, the detection area 132 having two kinds of arrangement intervals of the device columns A and C (FIGS. 26A and 26C) may be used, or the detection area 132 having three kinds of arrangement intervals of the device columns A, B and C (FIGS. 25 and 26B) may be used. In this case, the layout of the capacitance devices arranged in the detection area 132 is set as appropriate in accordance with a shape that sections the detection area 132. Of course, the arrangement examples shown in FIGS. 8, 10, and 12 can also be applied.

### Third Embodiment

FIG. 27 is a schematic plan view showing a configuration of an input apparatus according to an embodiment of the present technology. An input apparatus 81 in this embodiment may be configured as an input apparatus connected with the display apparatus like a laptop PC or the like, or may be configured as a single input apparatus independent of the display apparatus like a desktop PC or the like.

The input apparatus 81 in this embodiment includes a key input portion 811, a pressing force detection unit 813, and a control unit. The input apparatus 81 is electrically connected with a display unit (not shown), and an output with respect to an input operation of the input apparatus 81 is displayed on the display unit.

The key input portion 811 includes a plurality of input keys, and the pressing force detection unit 813 includes a detection area 133 where a pressing force can be electrostatically detected. On a basis of the pressing input operation in the detection area 133 and a motion thereof, the control unit generates a control signal that controls an image to be displayed on the display unit. The control unit has a configuration similar to the control unit 14 described in the first embodiment, and is incorporated in input apparatus 31.

The input apparatus 81 further includes a substantially rectangular plate-like main body 810, and the key input portion 811 and the pressing force detection unit 813 are disposed on the same surface of the main body 810. The key input unit 711 has a function as a keyboard, and the pressing force detection unit 813 has a function as a touch pad. The pressing force detection unit 813 is disposed in front of the key input unit 811 when viewed from a user side, but the position is not limited to this. The position of the pressing force detection unit 813 can be set in an area excluding the position described above as appropriate.

The pressing force detection unit 813 has a configuration similar to the pressing force detection unit 13 (FIG. 6) described in the first embodiment, so a detailed description thereof will be omitted. The detection area 133 is an area where a pressing input can be performed with a hand or a finger of the user. In the area, a plurality of sensors (capacitance elements 13s) described in the first embodiment is arranged in a matrix pattern.

A planar shape of the detection area 133 is not particularly limited, and typically, the detection area 133 is formed into a polygonal shape such as a rectangle. In this embodiment, as shown in FIG. 27, the detection area 133 is formed into a substantially rectangular shape substantially entirely in a width direction of the main body 810. A peripheral portion of the detection area 133 can be recognized in a visual or tactile manner, but this is not limited thereto.
The plurality of capacitance devices 13s disposed in the detection area 133 has the layout as shown in FIG. 7 in which the devices are arranged at the regular intervals in the two-axis directions of the X axis direction and the Y axis direction, but the layout thereof is not limited to this. The sensor layout shown in FIG. 8, FIG. 12, or the like may be used.

The input apparatus 81 in this embodiment is provided with the control unit that controls the image displayed on the display unit on the basis of the pressing input operation in the detection area 133 and the motion thereof. Here, the control unit electrostatically detects the pressing force in the detection area 133, and thus can detect various input operations by the user by performing comprehensive judgment for not only a binary input of on and off but also a degree of a pressure or the like at a time of on. As a result, it is possible to provide the operability fitted to an intention of the user.

The detection area 133 may be entirely used as the operation area, but only a specific area set by a selection operation by the user can be used as the operation area. In this embodiment, by the selection operation by the user, the control unit can set a part of the detection area 133 as an operation area where the pressing input operation is valid. As a result, only an area intended by the user is set as a valid operation area, so improvement of the operability can be achieved.

The control unit electrostatically detects the motion of the pressing input operation in the detection area 133 through the pressing force detection unit 813, and sets an operation range of the pressing input operation within the detection area 133 as the operation area (operation valid area) where the input operation is valid. After the operation area is set, the control unit controls the image displayed on the display unit on the basis of the pressing input operation in the set operation area and a motion thereof.

To achieve the control as described above, the control unit executes software (program) as follows. The software causes a step of electrostatically detecting the motion of the pressing input operation in the detection area 133, a step of setting an operation range of the pressing input operation in the detection area 133 as the operation area in which the input operation is valid, and a step of generating, on a basis of the pressing input operation in the operation area and the motion thereof, the control signal for controlling the image displayed on the display unit to be performed. The operation of the input apparatus 81 is performed by the CPU that constitutes the control unit and the software executed under the control thereof in cooperation with each other.

FIG. 28 is a schematic plan view for explaining a method of setting the operation area into the detection area 133. As shown in a left part of FIG. 28, to a predetermined area (substantially center area in the figure) in the detection area 133, the user inputs a predetermined gesture operation (for example, operation of drawing a circle). The control unit detects the input operation, and sets, to this operation range, an operation area 33E in which the pressing input operation is valid as shown in a right part of FIG. 28. The operation area 33E is set as an operation area for performing a pointing operation, for example.

FIG. 29 is a schematic plan view for explaining another method of setting the operation area. As shown in an upper left part of FIG. 29, to a predetermined area (on a right area in the figure) of the detection area 133, the user inputs a predetermined gesture operation (for example, operation of performing back and forth reciprocation along the Y axis direction). The control unit detects the input operation, and sets, to the operation range, an operation area 33E1 in which the pressing input operation is valid as shown in an upper right part of FIG. 29. Subsequently, as shown in a lower left part of FIG. 29, to a predetermined area (substantially center area in the figure) of the detection area 133, the user inputs a predetermined gesture operation (for example, operation of drawing a circle). The control unit detects the input operation, and sets, to the operation range, an operation area 33E2 in which the pressing input operation is valid as shown in a lower right part of FIG. 29. The operation area 33E1 is set as an operation area for performing a screen scroll, for example, and the operation area 33E2 is set as an operation area for performing a pointing operation, for example.

The operation areas 33E, 33E1, and 33E2 may not have to be clearly indicated for the user. However, for example, an LED (Light Emitting Diode) array is embedded in the detection area 133, and in areas or on outlines of the set operation areas 33E, 33E1, and 33E2, light may be emitted. A shape of the operation area 33E is not limited to the inverted trapezoid shown in the figure, and various shapes can be applied thereto.

It should be noted that, in a case where the positions and the sizes of the operation areas 33E, 33E1, and 33E2 are changed, for example, as in the first embodiment described above, a predetermined input operation is performed in an area excluding the operation areas 33E, 33E1, and 33E2, thereby cancelling the current setting of the operation area, and a new operation area only has to be set again.

In the above, the embodiments of the present technology are described. The present technology is not limited to only the above embodiments, and can of course be variously changed.

For example, in the first embodiment, the detection area 131 is provided on the frame-shaped portion 112F or on the back surface 112B of the casing unit 112, but is not limited to this. For example, the detection area 131 may be provided on a side peripheral surface of the casing unit 112.

Further, in the above embodiments, the pressing force detection unit is configured by the sensor device having the configuration as shown in FIG. 6, but in addition to this, various sensor devices capable of electrostatically detecting a pressing force can be applied thereto.

Furthermore, in the above embodiments, as the information processing apparatus or the input apparatus, the slate, desktop, or laptop information processing apparatus or input apparatus is given as the example in the description. In addition to those, the present technology can also be applied to a wearable apparatus or the like which is used in a state of being mounted on a user.

It should be noted that the present technology can take the following configuration.
(1) An information processing apparatus, including:
a main body having a display unit and a casing unit that supports the display unit;
a detection unit configured to have a detection area disposed on a surface of the casing unit and be capable of electrostatically detecting a pressing force to the detection area; and
a control unit configured to control an image displayed on the display unit on a basis of a pressing input operation in the detection area and a motion thereof.
(2) The information processing apparatus according to (1), in which
the control unit is configured to be capable of setting a part of the detection area as an operation area in which the pressing input operation is valid by a selection operation of a user.
(3) The information processing apparatus according to (1) or (2), in which
the detection unit includes
   a sensor sheet having a plurality of capacitance devices arranged in the detection area in a matrix pattern,
   an input operation surface which has a conductive layer, and is disposed to face the plurality of capacitance devices, and
   a support layer that elastically supports the input operation surface with respect to the sensor sheet.
(4) The information processing apparatus according to (3), in which
the plurality of capacitance devices has a plurality of device columns, arrangement intervals of the plurality of device columns along at least one direction being different from each other.
(5) The information processing apparatus according to (4), in which
the main body is configured to be capable of being operated in a state of being held by the user, and
the detection area has the device columns arranged at shorter intervals as the device columns are closer to a holding portion of the main body.
(6) The information processing apparatus according to any one of (3) to (5), in which
the detection unit further includes a structure that is formed on the input operation surface and has a three-dimensional shape.
(7) An information processing apparatus, including:
a display unit;
an operation member having a key input unit having a plurality of input keys and a detection area configured to be capable of electrostatically detecting a pressing force; and
a control unit configured to control an image displayed on the display unit on a basis of a pressing input operation in the detection area and a motion thereof.
(8) The information processing apparatus according to (7), in which
the control unit is configured to be capable of setting a part of the detection area as an operation area in which the pressing input operation is valid by a selection operation of a user.
(9) The information processing apparatus according to (7) or (8), in which
the detection unit includes
   a sensor sheet having a plurality of capacitance devices arranged in the detection area in a matrix pattern,
   an input operation surface which has a conductive layer, and is disposed to face the plurality of capacitance devices, and
   a support layer that elastically supports the input operation surface with respect to the sensor sheet, and
the plurality of capacitance devices has a plurality of device columns, arrangement intervals of the plurality of device columns along at least one direction being different from each other.
(10) The information processing apparatus according to (9), in which
the detection area is provided in a polygonal area sectioned on a surface of the operation member, and
the plurality of device columns is provided to correspond to an area whose width sizes along the one direction in the detection area are different from each other.
(11) An input apparatus, including:
a key input unit having a plurality of input keys;
a detection unit having a detection area configured to be capable of electrostatically detecting a pressing force; and
a control unit configured to generate a control signal that controls an image displayed on a display unit on a basis of a pressing input operation in the detection area and a motion thereof.
(12) A method of controlling an information processing apparatus having a display unit and a casing unit that supports the display unit, the method of controlling an information processing apparatus including:
electrostatically detecting a motion of a pressing input operation in a detection area provided on a surface of the casing unit;
setting an operation range of the pressing input operation in the detection area as an operation area in which an input operation is valid; and
controlling an image displayed on the display unit on a basis of the pressing input operation in the operation area and a motion thereof.
(13) A method of controlling an input apparatus having a key input unit having a plurality of input keys and a detection unit having a detection area configured to be capable of electrostatically detecting a pressing force, the method of controlling an input apparatus including:
electrostatically detecting a motion of a pressing input operation in the detection area;
setting an operation range of the pressing input operation in the detection area as an operation area in which an input operation is valid; and
controlling an image displayed on a display unit on a basis of the pressing input operation in the operation area and a motion thereof.
(14) A program for causing an information processing apparatus having a display unit and a casing unit that supports the display unit to execute:
a step of electrostatically detecting a motion of a pressing input operation in a detection area provided on a surface of the casing unit;
a step of setting an operation range of the pressing input operation in the detection area as an operation area in which an input operation is valid; and
a step of controlling an image displayed on the display unit on a basis of the pressing input operation in the operation area and a motion thereof.
(15) A program for causing an input apparatus having a key input unit having a plurality of input keys and a detection unit having a detection area configured to be capable of electrostatically detecting a pressing force to execute:
a step of electrostatically detecting a motion of a pressing input operation in the detection area;
a step of setting an operation range of the pressing input operation in the detection area as an operation area in which an input operation is valid; and a step of generating a control signal for controlling an image displayed on a display unit on a basis of the pressing input operation in the operation area and a motion thereof.

### REFERENCE SIGNS LIST

10, 20, 30, 40, 50, 60, 70 information processing apparatus
11 main body
13, 713, 813 pressing force detection unit
13E, 33E, 33E1, 33E2 operation area
13s capacitance device
14 control unit
71 operation member
72, 111 display unit
81 input apparatus
112 casing unit
131, 132, 133 detection area
310 sensor sheet
330 support layer
321 input operation surface
711, 811 key input unit

1. An information processing apparatus, comprising:
a main body having a display unit and a casing unit that supports the display unit;
a detection unit configured to have a detection area disposed on a surface of the casing unit and be capable of electrostatically detecting a pressing force to the detection area; and
a control unit configured to control an image displayed on the display unit on a basis of a pressing input operation in the detection area and a motion thereof.

2. The information processing apparatus according to claim 1, wherein
the control unit is configured to be capable of setting a part of the detection area as an operation area in which the pressing input operation is valid by a selection operation of a user.

3. The information processing apparatus according to claim 1, wherein
the detection unit includes
a sensor sheet having a plurality of capacitance devices arranged in the detection area in a matrix pattern,
an input operation surface which has a conductive layer, and is disposed to face the plurality of capacitance devices, and
a support layer that elastically supports the input operation surface with respect to the sensor sheet.

4. The information processing apparatus according to claim 3, wherein
the plurality of capacitance devices has a plurality of device columns, arrangement intervals of the plurality of device columns along at least one direction being different from each other.

5. The information processing apparatus according to claim 4, wherein
the main body is configured to be capable of being operated in a state of being held by the user, and
the detection area has the device columns arranged at shorter intervals as the device columns are closer to a holding portion of the main body.

6. The information processing apparatus according to claim 3, wherein
the detection unit further includes a structure that is formed on the input operation surface and has a three-dimensional shape.

7. An information processing apparatus, comprising:
a display unit;
an operation member having a key input unit having a plurality of input keys and a detection area configured to be capable of electrostatically detecting a pressing force; and
a control unit configured to control an image displayed on the display unit on a basis of a pressing input operation in the detection area and a motion thereof.

8. The information processing apparatus according to claim 7, wherein
the control unit is configured to be capable of setting a part of the detection area as an operation area in which the pressing input operation is valid by a selection operation of a user.

9. The information processing apparatus according to claim 7, wherein
the detection unit includes
a sensor sheet having a plurality of capacitance devices arranged in the detection area in a matrix pattern,
an input operation surface which has a conductive layer, and is disposed to face the plurality of capacitance devices, and
a support layer that elastically supports the input operation surface with respect to the sensor sheet, and
the plurality of capacitance devices has a plurality of device columns, arrangement intervals of the plurality of device columns along at least one direction being different from each other.

10. The information processing apparatus according to claim 9, wherein
the detection area is provided in a polygonal area sectioned on a surface of the operation member, and
the plurality of device columns is provided to correspond to an area whose width sizes along the one direction in the detection area are different from each other.

11. An input apparatus, comprising:
a key input unit having a plurality of input keys;
a detection unit having a detection area configured to be capable of electrostatically detecting a pressing force; and
a control unit configured to generate a control signal that controls an image displayed on a display unit on a basis of a pressing input operation in the detection area and a motion thereof.

12. A method of controlling an information processing apparatus having a display unit and a casing unit that supports the display unit, the method of controlling an information processing apparatus comprising:
electrostatically detecting a motion of a pressing input operation in a detection area provided on a surface of the casing unit;
setting an operation range of the pressing input operation in the detection area as an operation area in which an input operation is valid; and
controlling an image displayed on the display unit on a basis of the pressing input operation in the operation area and a motion thereof.

13. A method of controlling an input apparatus having a key input unit having a plurality of input keys and a detection unit having a detection area configured to be capable of electrostatically detecting a pressing force, the method of controlling an input apparatus comprising:
electrostatically detecting a motion of a pressing input operation in the detection area;
setting an operation range of the pressing input operation in the detection area as an operation area in which an input operation is valid; and
controlling an image displayed on a display unit on a basis of the pressing input operation in the operation area and a motion thereof.

14. A program for causing an information processing apparatus having a display unit and a casing unit that supports the display unit to execute:
a step of electrostatically detecting a motion of a pressing input operation in a detection area provided on a surface of the casing unit;
a step of setting an operation range of the pressing input operation in the detection area as an operation area in which an input operation is valid; and
a step of controlling an image displayed on the display unit on a basis of the pressing input operation in the operation area and a motion thereof.

15. A program for causing an input apparatus having a key input unit having a plurality of input keys and a detection unit having a detection area configured to be capable of electrostatically detecting a pressing force to execute:
a step of electrostatically detecting a motion of a pressing input operation in the detection area;
a step of setting an operation range of the pressing input operation in the detection area as an operation area in which an input operation is valid; and
a step of generating a control signal for controlling an image displayed on a display unit on a basis of the pressing input operation in the operation area and a motion thereof.
